(19) United States
(12) Patent Application Publication
(10) Pub. No.: US 2004/0205069 A1
(43) Pub. Date: Oct. 14, 2004

(54) Attached file management system, program, information storage medium, and method of managing attached file

(76) Inventor: Tomonori Ishizawa, Sakata-shi (JP)

Correspondence Address: HARNESS, DICKEY & PIERCE, P.L.C., P.O. BOX 828, BLOOMFIELD HILLS, MI, 48303, US

(21) Appl. No.: 10/756,804

(22) Filed: Jan. 13, 2004

(30) Foreign Application Priority Data
Jan. 14, 2003 (JP) 2003-005968

(51) Int. Cl. G06F 7/00; G06F 17/30; G06F 15/16

(52) U.S. Cl. 707/10; 709/203

(57) ABSTRACT

An attached file management system is provided which can reduce the data amount occupied by the attached file when transmitting and receiving electronic information. A server includes a communication part which intermediates the transmission and reception of electronic mail between PCs, a storage part which stores storage data, a file management part which determines whether or not an electronic mail transmitted by the PC includes a file. If the file is included, the file management part determines whether or not the file exists in the storage part. If the file does not exist, the file management part stores the file in the storage part and updates the storage data. The server also includes a server information generation part which generates access information based on the storage data if the electronic mail transmitted by the PC includes a file. The communication part transmits the access information to the transmission-destination PC.

### RELATED APPLICATIONS

The present application claims priority to Japanese Patent Application No. 2003-005968 filed Jan. 14, 2003 which is hereby expressly incorporated by reference.

### BACKGROUND OF THE INVENTION

1. Technical Field

The present invention relates to an attached file management system of electronic information, a program, an information storage medium, and a method of managing an attached file.

2. Background Art

In general, there are cases where network traffic is congested, because the same file is redundantly (e.g., in duplicate) stored among terminal units such as a plurality of PCs (Personal Computers) connected to a network, or the same file is transmitted and received.

In order to solve these problems, for a so-called client-server system, various methods of managing files have been proposed, for example, as described in Japanese Unexamined Patent Application Publication No. 10-63557, and the like.

For example, in Japanese Unexamined Patent Application Publication No. 10-63557, in order to provide a method of synchronizing distributed files, in which files are deleted from local computers and are stored only on a central computer, the changing of file states are managed by providing extended file management tables on a server and clients.

However, when storing data in the form of an object which is an integration of text data and a file, and not directly in the form of a file in a storage area of an HDD, etc., of a PC, and the like, a general method of managing a file cannot be directly applied.

Specifically, for example, when transmitting and receiving electronic mail with an attached file in a company, that attached file is stored in a mail server, a sender's PC, and a recipient's PC in the form of a mail object, and furthermore, remains in the sender's PC in the form of a file.

In particular, when sending electronic mail with an attached file to many recipients by broadcast communication, the larger the size of an attached file, the more remarkable is the congestion of the network traffic and the squeeze of the memory area.

Also, a recipient sometimes stores an attached file of a received electronic mail in his/her own PC with an additional name in another storage area. In such a case, the storage area is further squeezed.

The present invention is made in view of the above-described problems, and an object is to provide an attached file management system, a program, an information storage medium, and a method of managing an attached file, which can reduce the data amount occupied by the attached file in the entire system when transmitting and receiving electronic information with an attached file.

### SUMMARY

In order to solve the above-described problems, according to the present invention, there is provided an attached file management system for managing an attached file attached to electronic information transmitted and received by a plurality of terminal units, the system including:

intermediation means which intermediates transmission and reception of the electronic information;

server storage means which stores a plurality of files and server storage information indicating identification information of the files and storage location information in a predetermined storage area;

file management means which determines whether or not electronic information transmitted by a terminal unit contains a file, if the file is contained therein, the file management means determines whether or not the information exists in the storage area based on the server storage information, and if the file does not exist, the file management means stores the file in the storage area and updates the server storage information; and

if electronic information transmitted by the terminal unit contains the file, server information generation means which generates, based on the server storage information, access information including storage location information of the file and identification information of the file stored in the storage area and serving to access the file,

wherein the intermediation means transmits the access information at least to one of the terminal unit and at least one of the other terminal units.

Also, according to the present invention, there is provided a program for managing an attached file attached to electronic information transmitted and received by a plurality of terminal units, which is a computer-readable program, and

causes a computer to function as means comprising:

intermediation means which intermediates transmission and reception of the electronic information;

server storage means which stores a plurality of files and server storage information indicating identification information of the relevant files and storage location information in a predetermined storage area;

file management means which determines whether or not electronic information transmitted by a terminal unit contains a file, if the file is contained therein, the file management means determines whether or not the information exists in the storage area based on the server storage information, and if the file does not exists, the file management means stores the file in the storage area and updates the server storage information; and

if electronic information transmitted by the terminal unit contains the file, server information generation means which generates, based on the server storage information, access information including storage location information of the file and identification information of the file stored in the storage area and serving to access the file,

wherein the intermediation means transmits the access information to at least one of the terminal unit and at least one of the other terminal units.

Also, according to the present invention, there is provided an information storage medium, which is a computer-readable information storage medium, for storing the program described above.

Also, according to the present invention, there is provided a method of managing an attached file, which serves to manage information related to an attached file attached to electronic information transmitted and received by a plurality of terminal units, the method including steps in which:

a transmission-source terminal unit transmits electronic information to a server,

the server performing the steps of:

determining whether or not electronic information transmitted by a terminal unit contains a file, if the file is contained therein, determining whether or not the file exists in a predetermined storage area, and if the file does not exist, storing the file and server storage information indicating identification information and storage location information of the file in a predetermined storage area;

if electronic information transmitted by the terminal unit contains the file, generating, based on the server storage information, access information including storage location information of the file and identification information stored in the storage area and serving to access the file; and

transmitting the access information at least to one of the terminal unit and at least one of the other terminals.

According to the present invention, the terminal unit does not receive electronic information with an attached file, but receives access information for accessing the attached file.

Since the access information does not include an attached file, the terminal unit which has received the electronic information has a small amount of the storage area occupied by the access information.

Therefore, according to the present invention, in the attached file management system, and the like, the data amount occupied by the attached file in the entire system can be reduced when transmitting and receiving electronic information with an attached file.

In this regard, the electronic information described above includes, for example, electronic mail, contribution information to an electronic bulletin board, and the like.

Also, according to the present invention, there is provided an attached file management system for managing information related to an attached file attached to electronic information transmitted and received by a plurality of terminal units, the system including:

intermediation means which intermediates transmission and reception of the electronic information;

file management means which determines whether or not electronic information transmitted by a terminal unit contains file-related information including storage location information of a file, if the file-related information is contained therein, the file management means updates server storage information stored in a predetermined storage area based on the file-related information; and

if electronic information transmitted by the terminal unit contains the file-related information, server information generation means which generates, based on the server storage information, access information including storage location information of the file and identification information of the file stored in the storage area and serving to access the file,

wherein the intermediation means transmits the access information to at least one of the terminal unit and at least one of the other terminal units.

Also, according to the present invention, there is provided a program for managing information related to an attached file attached to electronic information, which is a computer-readable program, and

causes a computer to function as means comprising:

intermediation means which intermediates transmission and reception of the electronic information;

file management means which determines whether or not electronic information transmitted by a terminal unit contains file-related information including storage location information of a file, if the file-related information is contained therein, the file management means updates server storage information stored in a predetermined storage area based on the file-related information; and

if electronic information transmitted by the terminal unit contains the file-related information, server information generation means which generates, based on the server storage information, access information including storage location information of the file and identification information of the file stored in the storage area and serves for accessing the file,

wherein the intermediation means transmits the access information to at least one of the terminal unit and at least one of the other terminal units.

Also, according to the present invention, there is provided an information storage medium, which is a computer-readable information storage medium, for storing the program described above.

Also, according to the present invention, there is provided a method of managing an attached file, which serves to manage information related to an attached file attached to electronic information transmitted and received by a plurality of terminal units, the method including steps in which:

a transmission-source terminal unit transmits electronic information to a server,

the server performing the steps of:

determining whether or not electronic information transmitted by a terminal unit contains file-related information including storage location information of a file;

if the file-related information is contained therein, updating the server storage information stored in a predetermined storage area based on the file-related information; and generating, based on the server storage information, access information including storage location information of the file and identification information of the file stored in the storage area and serving to access the file; and

transmitting the access information at least to one of the terminal unit and at least one of the other terminal units.

According to the present invention, the terminal unit does not receive electronic information with an attached file, but receives access information for accessing the attached file.

Since the access information does not include an attached file, the terminal unit which has received the electronic information has a small amount of the storage area occupied by the access information.

Therefore, according to the present invention, in the attached file management system, and the like, the data amount occupied by the attached file in the entire system can be reduced when transmitting and receiving electronic information with an attached file.

In this regard, the electronic information described above includes, for example, electronic mail, contribution information to an electronic bulletin board, and the like.

Also, according to the present embodiment, in the attached file management system, and the like, since the server does not store a file, when compared to the case where a file is managed by the server, the data amount occupied by the attached file in the entire system can be reduced.

Also, in the attached file management system, the program, and the information storage medium, the electronic information may be electronic mail, and the intermediation means may transmit the access information to a transmission-destination terminal unit of the electronic mail.

Also, in the method of managing an attached file, the electronic information may be an electronic mail, and the server may transmit the access information to the transmission-destination terminal unit of the electronic mail.

Accordingly, in the attached file management system, and the like, the data amount occupied by the attached file of the electronic mail can be reduced.

In particular, in the case of an electronic mail, electronic mail with an attached file is sometimes transmitted to a large number of terminal units, and thus the effect of the reduction of the data amount occupied by the present invention becomes remarkable.

Also, in the attached file management system, the program, and the information storage medium, the server storage information may include last update date-and-time information of the file, the file management means may determine whether there is a duplicate file based on the file identification information, the last update date-and-time information, and the server storage information at regular time intervals or in response to a user's request, and if there is a duplicate file, the file management means may delete the duplicate file other than the file having the latest last-update date and time.

Also, in the method of managing an attached file, the server storage information may include last-update date-and-time information of the file, the server may determine whether there is a duplicate file based on the file identification information and the server storage information at regular time intervals or in response to a user's request, and if there is a duplicate file, the server may delete the duplicate file.

Accordingly, in the method of managing an attached file, and the like, since a duplicate file can be deleted based on the server storage information, the data amount occupied by the attached file in the entire system can be further reduced.

In this regard, as a criterion of determination of a duplicate file, for example, the same file identification name, or the same file identification name and the same last update date and time may be used.

Also, in the attached file management system, the program, and the information storage medium, when there is a duplicate file, the server information generation means may generate a file clean-up electronic mail, which prompts the user to clean up the files, and the intermediation means may transmit the file clean-up electronic mail to the transmission-source terminal unit.

Also, in the attached file management system, when there is a duplicate file, the server may generate file clean-up information, which prompts the user to clean up the files, and may transmit the file clean-up information to the transmission-source terminal unit of the electronic information.

Accordingly, the file management system, and the like can clean up duplicate files by the user's selection, and thus the reduction of the data amount occupied, which is suitable for the user's purpose, can be performed.

Also, in the attached file management system, the program, and the information storage medium, the terminal unit may include:

terminal information generation means for generating electronic information including identification information and storage location information of the file;

communication means for transmitting and receiving the electronic information;

terminal storage means for storing terminal storage information indicating identification information and storage location information of a plurality of the files in a predetermined storage area; and

update means for updating the file and the terminal storage information,

wherein, if there is a duplicate file, the server information generation means generates file-deletion information in order to delete the duplicated file other than the file having the latest last-update date and time,

the intermediation means transmits the file-deletion information to the transmission-source terminal unit of the electronic information, and

the update means deletes the duplicate file other than a file having the latest last-update date and time based on the file-deletion electronic information, and updates the terminal storage information.

Also, in the method of managing an attached file, the terminal unit may include the steps of:

storing a plurality of the files and terminal storage information indicating identification information and storage location information of the files in a predetermined storage area; and

generating electronic information including update means for updating the file and the terminal storage information, and

the identification information of the files and the storage location information of the files,

the server may include the steps of:

if there is a duplicate file, generating a file-deletion electronic mail in order to delete the duplicate file; and

transmitting the file-deletion electronic mail to the transmission-source terminal unit, and

the terminal unit may include the steps of:

deleting the duplicate file based on the file-deletion electronic mail, and updating the terminal storage information.

Accordingly, in the attached file management system, and the like, the data amount occupied can be reduced by deleting a duplicate file regardless of the existence of the transmission and reception of electronic information.

Also, in the attached file management system, the program, and the information storage medium, the file management means may manage at least one of access rights of the storage area and the file indicated by the storage location information for each of the terminal units, may determine whether or not the transmission-destination terminal unit has the access right based on an electronic mail transmitted by the terminal unit, and

if the transmission-destination terminal unit does not have the access right, the intermediation means may transmit the electronic mail transmitted by the terminal unit to the transmission-destination terminal unit in place of the access information.

Also, in the method of managing an attached file, the server may include the steps of:

managing at least one of access rights of the storage area and the file indicated by the storage location information for each of the terminal units; determining whether or not the transmission-destination terminal unit has the access right based on an electronic mail transmitted by the terminal unit, and if the transmission-destination terminal unit does not have the access right, transmitting the electronic mail transmitted by the terminal unit to the transmission-destination terminal unit in place of the access information.

Accordingly, in the method of managing an attached file, and the like, by determining whether access information is applied or the electronic mail is applied in consideration of an access right, the data amount occupied can be reduced in a state of high security.

### BRIEF DESCRIPTION OF THE DRAWINGS

FIG. 1 is a general view of an attached file management system according to an embodiment of the present invention.

FIG. 2 is a diagram illustrating an example of an electronic-mail transmission image according to the embodiment of the present invention.

FIG. 3 is a functional block diagram of a server and a PC according to the embodiment of the present invention.

FIG. 4 is a schematic diagram illustrating the data structure of the storage data of the PC according to the embodiment of the present invention.

FIG. 5 is a schematic diagram illustrating the data structure of the storage data of the server according to the embodiment of the present invention.

FIG. 6 is a schematic diagram illustrating the data structure of access data according to the embodiment of the present invention.

FIG. 7 is a flow chart illustrating the flow of the electronic-mail transmission processing according to the embodiment of the present invention.

### DETAILED DESCRIPTION

In the following, a description will be given of the present invention using examples of applying the invention to an attached file management system with reference to the drawings. In this regard, the embodiments described below are not intended as a definition of the limits of the contents of the invention set forth in the appended claims. Also, all the configuration described in the following embodiments are not necessarily required for solving means of the invention set forth in the appended claims.

Embodiment

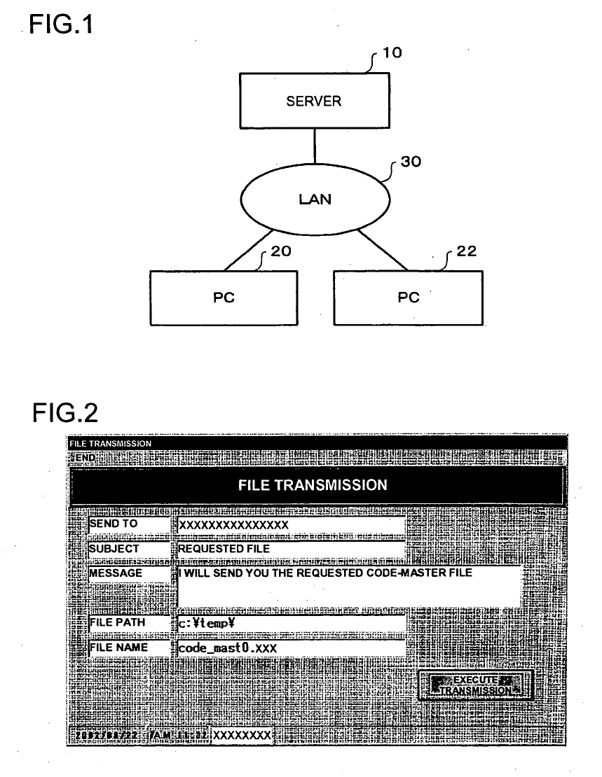

FIG. 1 is a general view of an attached file management system according to an embodiment of the present invention.

A plurality of PCs 20 and 22, each of which is a kind of terminal unit, are connected to a server 10, which functions as an attached file management system, through a LAN 30. In this regard, in general, the number of PCs 20, and the like are three or more. However, for simplification of description, the two PCs 20 and 22 are shown here.

For example, when the PC 20 sends an electronic mail, which is a kind of electronic information, to the PC 22, an image as shown in the following is displayed in the screen of the PC 20.

FIG. 2 is a diagram illustrating an example of an electronic-mail transmission image according to the embodiment of the present invention.

In a state in which the electronic-mail transmission image is displayed, the user of the PC 20 enters “Send to”, “Subject”, and “Message” using a keyboard, or the like, and clicks on the “Execute transmission” (or “send”) button image to send the electronic mail.

In this regard, “File PATH” and “File name”, which indicate a file storage location, are automatically input by the user selecting a file in a state of displaying an attached file selection image before displaying an electronic-mail transmission image. Of course, the user may directly enter “File PATH” and “File name”.

Also, the electronic-mail transmission image shown in FIG. 2 is an image produced by a proprietary application software. However, commercially available electronic-mail transmission application software may be used.

The server 10 has a function of mail service, and intermediates the transmission and reception of electronic mail between the PC 20 and the PC 22.

When the “Execute transmission” button image is clicked, the PC 20 sends an electronic mail including “File PATH”, which is the storage location information of a file, and “File name”, which is the identification information of a file, to the server 10 in addition to information such as “Send to”, and the like.

The server 10 determines whether or not the electronic mail sent by the PC 20 includes file-related information, and if the file-related information is included, the server 10 updates server storage information indicating the storage location of a file, and the like.

Then the server 10 generates access information which includes storage location information of a file and identification information of the file, the access information allows the transmission-destination PC 22 to access the file based on the server storage information, and the server 10 transmits the access information to the PC 22.

Then the PC 22 reads the file, and writes the file based on the access information.

Accordingly, the user of the PC 22 can use a file attached to an electronic mail without receiving an attached file of the electronic mail, or without the file being stored in duplicate to the transmission-source PC 20 and the transmission-destination PC 22 unlike conventional cases so far.

Thus it is possible to reduce the amount of storage area occupied by attached files of electronic mail in the entire system.

Next, a description will be given of the functional blocks of the server 10 and the PC 20 for achieving these functions.

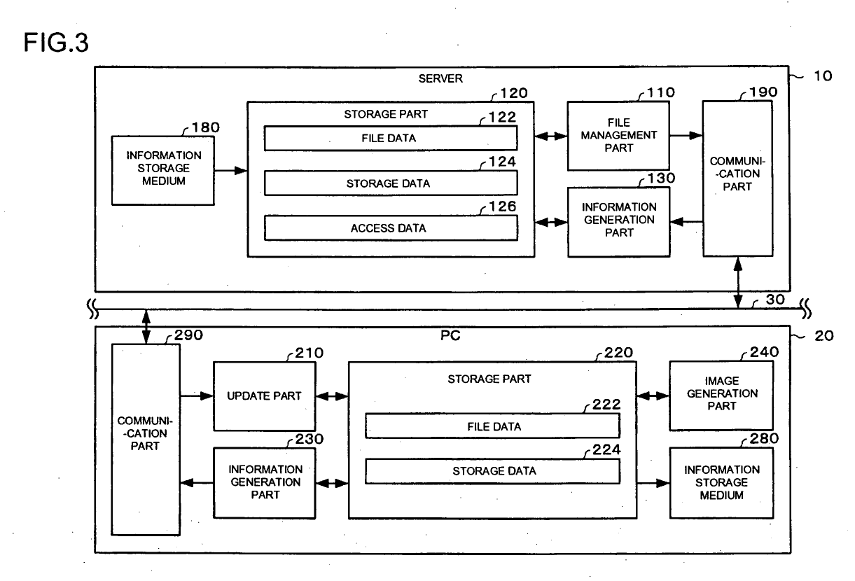

FIG. 3 is a functional block diagram of the server 10 and the PC 20 according to an embodiment of the present invention.

The server 10 determines whether or not the electronic mail transmitted by the PC 20 includes file-related information, and if the file-related information is included, the server 10 includes a file management part 110 which updates storage data 124 indicating a storage location of a file, and the like, and a storage part 120 which stores the storage data 124, and the like.

Also, the server 10 includes an information generation part 130, which functions as server information generation means for generating, based on the storage data 124, access information including storage location information of the file and identification information of the file, and for allowing the transmission-destination PC 22 to access the file, and a communication part 190, which transmits the access information to the PC 22, and functions as intermediation means for intermediating electronic information with the PC 20.

Also, the PC 20 stores an update part 210, which updates the storage data 224, and the like, a storage part 220 which stores the storage data 224, and the like, an information generation part 230, which is terminal information generation means for generating electronic mail, and an image generation part 240 which generates an image.

Also, the file management part 110 of the server 10 obtains the last-update date and time of the file by referring to the attribute information of the file and the storage data 224 based on the storage location information of the files included in the file-related information. Then the file management part 110 writes the obtained last update date and time in the relevant part of the file in the storage data 124.

In this regard, the information generation part 230 of the PC 20 may generate an electronic mail including the last update date and time of the file in the file-related information.

Also, the storage part 120 of the server 10 stores file data 122 having a plurality of files, the storage data 124, which is a kind of server storage information, and access data 126. Also, the storage part 220 of the PC 20 stores file data 222, and storage data 224 which is a kind of terminal storage information.

Here, a description will be given of the data structure of this data.

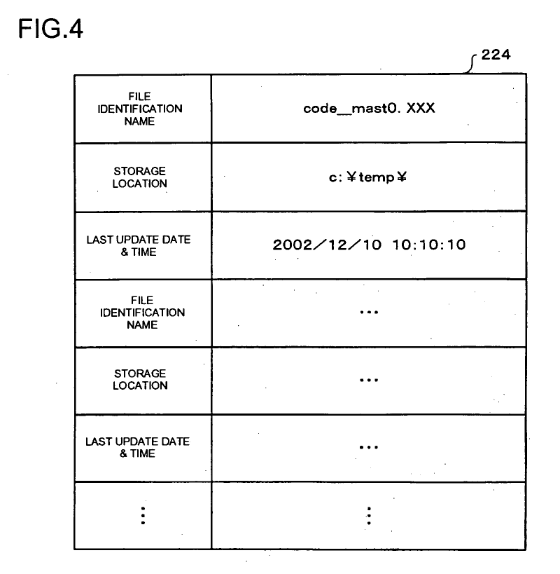

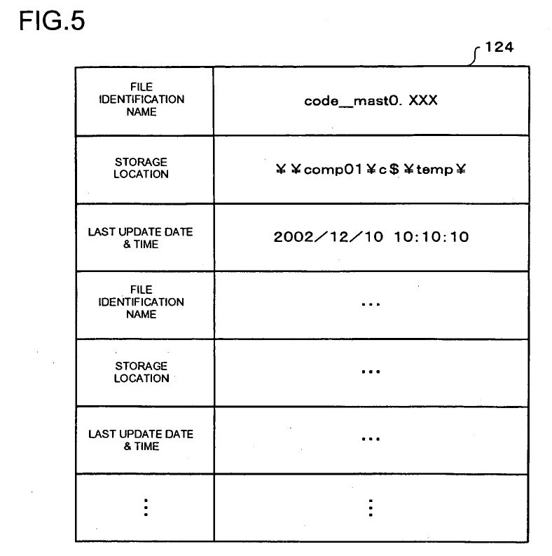

FIG. 4 is a schematic diagram illustrating the data structure of the storage data 224 of the PC 20 according to an embodiment of the present invention.

As shown in FIG. 4, the items of the storage data 224 are, for example, “File identification name”, “Storage location” indicating the storage location (path) of the file, “Last update date and time” indicating the last update date and time of the file, and the like. The storage data 224 has “File identification name”, and the like for each file.

Specifically, for example, in the case of the file “code_mast0.XXX” shown in FIG. 2, in the storage data 224, “File identification name” is “code_mast0.XXX”, “Storage location” is “c:\temp”, and “Last update date and time” is “2002 Dec. 10, 10:10:10”.

When the storage location and the contents of the file are updated, the update part 210 updates “Storage location” and “Last update date and time” in the storage data 224.

Next, a description will be given of the storage data 124 of the server 10.

FIG. 5 is a schematic diagram illustrating the data structure of the storage data 124 of the server 10 according to an embodiment of the present invention.

The data structure of the storage data 124 is the same as the data structure of the storage data 224. However, the “Storage location” of the storage data 224 directly indicates the storage location of the PC 20, whereas the “Storage location” of the storage data 124 indicates the storage location including the computer name of the PC 20.

Specifically, for example, when “Storage location” of the storage data 224 of the PC 20 is “c:\temp”, “Storage location” of the storage data 124 corresponding to the file is “\\comp01\c$\temp\”. In this regard, here “comp01” is a computer name of the PC 20, and the notation using “\”, “$”, and the like is different depending on the operating system, and the like to be applied.

As described above, the file management part 110 obtains information of the last update date and time of the file, and writes it into the storage data 124.

Next, a description will be given of the data structure of the access data 126.

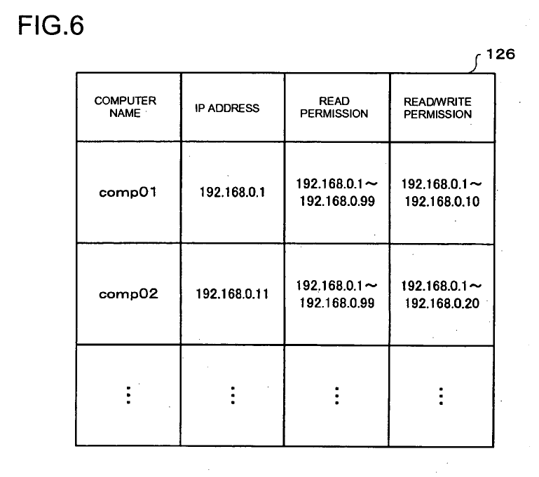

FIG. 6 is a schematic diagram illustrating the data structure of the access data 126 according to an embodiment of the present invention.

The access data 126 is the data for managing access rights, and is the data indicating the range of the storage area accessible by the PC 20, and the like. The items of the access data 126 are “Computer name”, “IP address”, “Read permission”, which indicates the range of IP addresses of read-permissible PC 20, and the like, “Read/write permission”, which indicates the range of IP addresses of read/write permissible PC 20, and the like.

In this regard, in the present embodiment, it is assumed that a unique IP address is assigned to each PC 20, and the like.

Specifically, for example, “Computer name” of the PC 20 is “comp01”, “IP address” is “192.168.0.1”, “Read permission” is “192.168.0.1 to 192.168.0.99”, and “Read/write permission” is “192.168.0.1 to 192.168.0.10”.

Also, for example, “Computer name” of the PC 22 is “comp02”, “IP address” is “192.168.0.11”, “Read permission” is “192.168.0.1 to 192.168.0.99”, and “Read/write permission” is “192.168.0.1 to 192.168.0.20”.

In this case, the PC 22 can read and write the data of the storage area of the PC 20. However, the PC 20 cannot read and write the data of the PC 22, and can only read that data.

In this regard, here, the access data 126 indicates an access right for each storage area of the PC 20, and the like. However, the access data 126 may have a structure so that access rights are indicated by access rights in smaller units, such as by each file, or by each directory (folder).

Also, for hardware for achieving each part, such as the file management part 110, and the like, for example, a CPU, or the like can be used for, for example, the file management part 110, the information generation parts 130 and 230, and the update part 219; for example, an HDD, or the like can be used for the storage parts 120 and 220; for example, an image generation circuit, or the like can be used for the image generation part 240; and for example, a LAN board, or the like can be used for the communication part 190 and the communication part 290.

Also, the server 10 can function as each of the parts by reading the program stored in the information storage medium 180, and the PC 20, and the like can function as each of the parts by reading the program stored in the information storage medium 280.

To the information storage media 180 and 280 described above, for example, a CD-ROM, a DVD-ROM, a ROM, a RAM, an HDD, and the like can be applied, and the method of reading the program may be a contact method, or a non-contact method.

Also, in place of the information storage media 180 and 280, it is possible to achieve each of the functions described above by downloading the programs, and the like from a host machine, or the like through a transmission path for achieving each function described above.

In this regard, the other PC 22 has the same structure as that of the PC 20.

Next, a description will be given of the flow of the electronic mail transmission process using each of these parts.

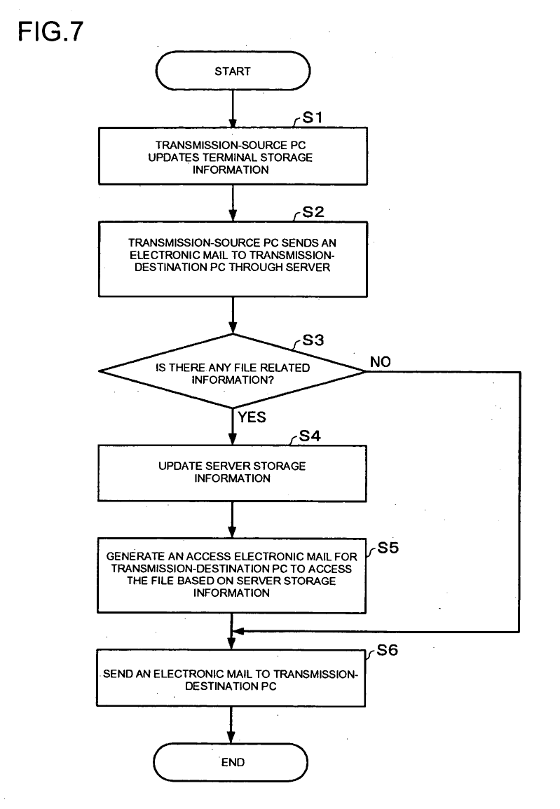

FIG. 7 is a flowchart illustrating the flow of the electronic-mail transmission processing according to an embodiment of the present invention.

First, when having updated a file, the transmission-source PC 20 updates the storage data 224, which is the terminal storage information (step S1).

Then the transmission-source PC 20 transmits an electronic mail to the transmission-destination PC 22 through the server 10 (step S2).

The server 10 receives the electronic mail using the communication part 190, and determines whether or not the electronic mail includes file-related information using the file management part 110 (step S3).

Then if the electronic mail includes the file-related information, the file management part 110 updates the storage data 124, which is the server storage information (step S4).

The information generation part 130 generates access information for the transmission-destination PC 22 to access an attached file based on the storage data 124 (step S5).

More specifically, the information generation part 130 generates access information including the storage location information and identification information of the part corresponding to the attached file, and the text data of the electronic mail other than the attached file in the storage data 124 shown in FIG. 5.

For example, in the case of the embodiment described above, the access information includes “\\comp01\c$\temp\” as the storage location information, “code_mast0.XXX” as the identification information, and the text data of the electronic mail other than the attached file. As described above, the access data does not include the data itself of the attached file.

Then when the electronic mail includes file-related information, the communication part 190 transmits the access information to the transmission-destination PC 22 (step S6). Also, when the electronic mail does not include file-related information, the communication part 190 directly transmits the electronic mail transmitted from the transmission-source PC 20 to the transmission-destination PC 22 (step S6).

In this regard, when an attached file is not attached, the transmission-destination PC 22 can read and write the attached file in accordance with the access right by referring to the access information.

As described above, according to the present embodiment, the transmission-destination PC 22 does not receive an electronic mail with an attached file, but receives access information for accessing the attached file.

As described above, since the access information does not include an attached file, the amount of the storage area of the PC 22 occupied by the access information is small.

Therefore, according to the present embodiment, in the server 10, the data amount occupied by attached files in the entire system can be reduced when transmitting and receiving electronic information with an attached file.

Also, according to the present embodiment, since the server 10 does not store files, when compared to the case where a file is redundantly (e.g., in duplicate) managed by the server 10 and the PC 20, the data amount occupied y the attached file in the entire system can be further reduced.

Also, according to the present embodiment, in the server 10, the data amount occupied by the attached file of the electronic mail can be reduced.

In particular, in the case of an electronic mail, an electronic mail with an attached file may sometimes be transmitted to a large number of PCs, and thus the effect of the reduction of the data amount occupied by the present embodiment becomes remarkable.

Modification

In the above, a description has been given of a preferred embodiment to which the present invention is applied. However, the present invention is not limited to the embodiment described above.

For example, in the embodiment described above, the file management is performed by both the server 10 and the PC 20. However, the attached file management may be performed only by the server 10.

In this case, it is not necessary for the information generation part 230 to generate file-related information, and for the file management part 110 to refer to the file-related information. The file management part 110 may determine whether or not an electronic mail includes a file, and may perform the processing described above.

Accordingly, in addition to the effects of the operation described above, the occurrence of a situation in which a formal version of a file is not known by the existence of a number of duplicate files can be prevented.

Also, in the embodiment described above, the server 10 checks for a duplicate file when transmitting electronic mail. However, the file management part 110 may determine whether there is a duplicate file based on “Last update date and time” of the storage data 124, and may delete an OLE_LINK1 duplicate file at regular time intervals, or may delete the duplicate file in response to the user's request.

Accordingly, the server 10 can further reduce the data amount occupied by deleting a duplicate file regardless of the existence of the transmission and reception of the electronic information.

In this regard, the file management part 110 may determine whether there is a duplicate file by referring to not only the storage data 124, but also the storage data 224 of the PC.

Also, when there is a duplicate file, the information generation part 130 may generate file clean-up information, which prompts the user to clean up the files. The communication part 190 may transmit the file clean-up information to the transmission-destination PC.

Accordingly, the file management system, and the like can clean up duplicate files by the user's selection, and thus the reduction of the data amount occupied, which is suitable for the user's purpose, can be performed.

Also, when deleting a duplicate file, the information generation part 130 may generate information for the user to select, as file clean-up information, for example, “Keep a file”, “Rename”, “Store in another place”, “Delete an existing file and then save a new file”, “Keep an existing file without saving a new file”, “Rename an existing file and then save a new file”, “Rename a new file and then save the new file”, and “Save a new file in a specified folder”. Also, the information generation part 130 may generate information which gives a warning of the existence of a duplicate file to the user.

Also, when the user selects “Keep a file” regardless of the existence of a duplicate file, the system may cause the user to enter the reason therefore, a manager, an execution date and time, a retention period, and the like, and may store them in the storage part 120 in order for the PC to refer to the reason, and the like. Also, in this case, in order to reduce the data amount occupied, the file management part 110 may automatically delete a file whose retention period is exceeded.

Also, the information generation part 130 may determine whether the transmission-destination PC of an electronic mail has an access right to the file using the access data 126 described above. If it is determined to have the access right, the communication part 190 may transmit the access information, and if it is determined not to have the access right, the communication part 190 may directly transmit the electronic mail with an attached file.

Accordingly, the server 10 determines whether the server 10 applies access information or the electronic mail in consideration of the access right. Thus the data amount occupied can be reduced in a state of high security.

Also, in the embodiment described above, a description has been given of the case where the PC 20 transmits and receives an attached file of an electronic mail. However, the present invention may also be applied, for example, to the case of transmitting and receiving electronic information such as contribution information to an electronic bulletin board in addition to electronic mail.

Also, in the embodiment described above, the attached file management system is achieved using the server 10. However, the attached file management system may be achieved by distributing the functions of the server 10 to a plurality of apparatuses.

What is claimed is:

1. An attached file management system for managing an attached file attached to electronic information transmitted and received by a plurality of terminal units, the system comprising:
intermediation means which intermediates transmission and reception of the electronic information;
server storage means which stores a plurality of files and server storage information indicating identification information of the files and storage location information in a predetermined storage area;
file management means which determines whether electronic information transmitted by a terminal unit contains a file and:
if the file is contained in the electronic information, the file management means determines whether the information exists in the storage area based on the server storage information; and
if the file is not contained in the electronic information, the file management means stores the file in the storage area and updates the server storage information; and
if electronic information transmitted by the terminal unit contains the file, server information generation means which generates, based on the server storage information, access information including storage location information of the file and identification information of the file stored in the storage area and serving to access the file,
wherein the intermediation means transmits the access information at least to one of the terminal unit and at least one other of the plurality of terminal units.

2. An attached file management system for managing information related to an attached file attached to electronic information transmitted and received by a plurality of terminal units, the system comprising:
intermediation means which intermediates transmission and reception of the electronic information;
file management means which determines whether electronic information transmitted by a terminal unit contains file-related information including storage location information of a file, and:
if the file-related information is contained in the electronic information, the file management means updates server storage information stored in a predetermined storage area based on the file-related information; and
if electronic information transmitted by the terminal unit contains the file-related information, server information generation means which generates, based on the server storage information, access information including storage location information of the file and identification information of the file stored in the storage area and serving to access the file,
wherein the intermediation means transmits the access information to at least one of the terminal unit and at least one other of the plurality of terminal units.

3. The attached file management system according to claim 1,
wherein the electronic information further comprises an electronic mail, and
the intermediation means transmits the access information to a transmission-destination terminal unit of the electronic mail.

4. The attached file management system according to claim 1,
wherein the server storage information includes last update date-and-time information of the file,
the file management means determines whether there is a duplicate file based on the file identification information, the last update date-and-time information, and the server storage information at least at one of regular time intervals and in response to a user request, and if there is a duplicate file, the file management means deletes the duplicate file which does not have the latest last-update date and time.

5. The attached file management system according to claim 4,
wherein, if there is a duplicate file, the server information generation means generates a file-clean-up electronic mail prompting the user to clean up the files, and
the intermediation means transmits the file-clean-up electronic mail to the transmission-source terminal unit.

6. The attached file management system according to claim 4,
wherein the terminal unit includes:
terminal information generation means for generating electronic information including identification information and storage location information of the file;
communication means for transmitting and receiving the electronic information;
terminal storage means for storing terminal storage information indicating identification information and storage location information of a plurality of the files in a predetermined storage area; and
update means for updating the file and the terminal storage information,
wherein:
if there is a duplicate file, the server information generation means generates file-deletion information in order to delete the duplicated file that does not have the latest last-update date and time;
the intermediation means transmits the file-deletion information to the transmission-source terminal unit of the electronic information; and
the update means deletes the duplicate file that does not have the latest last-update date and time based on the file-deletion information, and updates the terminal storage information.

7. The attached file management system according to claim 3,
wherein the file management means manages at least one of an access right of the storage area and the file indicated by the storage location information for each of the terminal units, determines whether the transmission-destination terminal unit has the access right based on an electronic mail transmitted by the terminal unit, and
if the transmission-destination terminal unit does not have the access right, the intermediation means transmits the electronic mail transmitted by the terminal unit to the transmission-destination terminal unit in place of the access information.

8. A program for managing an attached file attached to electronic information transmitted and received by a plurality of terminal units, which is a computer-readable program, and causes a computer to function as means comprising:
intermediation means which intermediates transmission and reception of the electronic information;
server storage means which stores a plurality of files and server storage information indicating identification information of the relevant files and storage location information in a predetermined storage area;
file management means which determines whether electronic information transmitted by a terminal unit contains a file and:
if the file is contained in the electronic information, the file management means determines whether the information exists in the storage area based on the server storage information; and
if the file is not contained in the electronic information, the file management means stores the file in the storage area and updates the server storage information; and
if electronic information transmitted by the terminal unit contains the file, server information generation means which generates, based on the server storage information, access information including storage location information of the file and identification information of the file stored in the storage area and serving to access the file,
wherein the intermediation means transmits the access information to at least one of the terminal unit and at least one other of the plurality of terminal units.

9. A program for managing information related to an attached file attached to electronic information, which is a computer-readable program, and causes a computer to function as means comprising:
intermediation means which intermediates transmission and reception of the electronic information;
file management means which determines whether electronic information transmitted by a terminal unit contains file-related information including storage location information of a file and:
if the file-related information is contained in the electronic information, the file management means updates server storage information stored in a predetermined storage area based on the file-related information; and
if electronic information transmitted by the terminal unit contains the file-related information, server information generation means which generates, based on the server storage information, access information including storage location information of the file and identification information of the file stored in the storage area and serves for accessing the file,
wherein the intermediation means transmits the access information to at least one of the terminal unit and at least one other of the plurality of terminal units.

10. An information storage medium, which is a computer-readable information storage medium, for storing a program according to claim 8.

11. A method of managing an attached file, which serves to manage information related to an attached file attached to electronic information transmitted and received by a plurality of terminal units, the method including steps in which:
a transmission-source terminal unit transmits electronic information to a server,
the server performing the steps of:
determining whether electronic information transmitted by a terminal unit contains a file, and:
if the file is contained in the electronic information, determining whether the file exists in a predetermined storage area; and
if the file is not contained in the electronic information, storing the file and server storage information indicating identification information and storage location information of the file in a predetermined storage area;
if electronic information transmitted by the terminal unit contains the file, generating, based on the server storage information, access information including storage location information of the file and identification information stored in the storage area and serving to access the file; and
transmitting the access information at least to one of the terminal unit and at least one other of the plurality of terminal units.

12. A method of managing an attached file, which serves to manage information related to an attached file attached to electronic information transmitted and received by a plurality of terminal units, the method including steps in which:
a transmission-source terminal unit transmits electronic information to a server,
the server performing the steps of:
determining whether electronic information transmitted by a terminal unit contains file-related information including storage location information of a file;
if the file-related information is contained in the electronic information, updating the server storage information stored in a predetermined storage area based on the file-related information; and
generating, based on the server storage information, access information including storage location information of the file and identification information of the file stored in the storage area and serving to access the file; and
transmitting the access information at least to one of the terminal unit and at least one other of the plurality of terminal units.

13. The method of managing an attached file according to claim 11,
wherein the electronic information further comprises an electronic mail, and
the server transmits the access information to the transmission-destination terminal unit of the electronic mail.

14. The method of managing an attached file according to claim 11,
wherein the server storage information includes last-update date-and-time information of the file,
the server determines whether there is a duplicate file based on the file identification information and the server storage information at least at one of regular time intervals and in response to a user request, and if there is a duplicate file, the server deletes the duplicate file.

15. The method of managing an attached file according to claim 14,
wherein the server performs the steps of:
generating a file-clean-up electronic mail prompting the user to clean up the files if there is a duplicate file; and
transmitting the file-clean-up electronic mail to the transmission-source terminal unit.

16. The method of managing an attached file according to claim 14,
wherein the terminal unit performs the steps of:
storing a plurality of the files and terminal storage information indicating identification information and storage location information of the files in a predetermined storage area; and
generating electronic information including update means for updating the file and the terminal storage information, and
the identification information of the files and storage location information of the files,
the server performing the steps of:
if there is a duplicate file, generating a file-deletion electronic mail in order to delete the duplicate file; and
transmitting the file-deletion electronic mail to the transmission-source terminal unit, and
the terminal unit performing the steps of:
deleting the duplicate file based on the file-deletion electronic mail, and updating the terminal storage information.

17. The method of managing an attached file according to claim 13 wherein the server performs the steps of:
managing at least one of an access right of the storage area and the file indicated by the storage location information for each of the terminal units; determining whether the transmission-destination terminal unit has the access right based on an electronic mail transmitted by the terminal unit, and if the transmission-destination terminal unit does not have the access right, transmitting the electronic mail transmitted by the terminal unit to the transmission-destination terminal unit in place of the access information.

18. The attached file management system according to claim 2,
wherein the electronic information further comprises an electronic mail, and
the intermediation means transmits the access information to a transmission-destination terminal unit of the electronic mail.

19. The attached file management system according to claim 2,
wherein the server storage information includes last update date-and-time information of the file,
the file management means determines whether there is a duplicate file based on the file identification information, the last update date-and-time information, and the server storage information at least at one of regular time intervals and in response to a user request, and if there is a duplicate file, the file management means deletes the duplicate file which does not have the latest last-update date and time.

20. The attached file management system according to claim 19,
wherein, if there is a duplicate file, the server information generation means generates a file-clean-up electronic mail prompting the user to clean up the files, and
the intermediation means transmits the file-clean-up electronic mail to the transmission-source terminal unit.

21. The attached file management system according to claim 19,
wherein the terminal unit includes:
terminal information generation means for generating electronic information including identification information and storage location information of the file;
communication means for transmitting and receiving the electronic information;
terminal storage means for storing terminal storage information indicating identification information and storage location information of a plurality of the files in a predetermined storage area; and
update means for updating the file and the terminal storage information,
wherein:
if there is a duplicate file, the server information generation means generates file-deletion information in order to delete the duplicated file that does not have the latest last-update date and time;
the intermediation means transmits the file-deletion information to the transmission-source terminal unit of the electronic information; and
the update means deletes the duplicate file that does not have the latest last-update date and time based on the file-deletion information, and updates the terminal storage information.

22. The attached file management system according to claim 18,
wherein the file management means manages at least one of an access right of the storage area and the file indicated by the storage location information for each of the terminal units, determines whether the transmission-destination terminal unit has the access right based on an electronic mail transmitted by the terminal unit, and
if the transmission-destination terminal unit does not have the access right, the intermediation means transmits the electronic mail transmitted by the terminal unit to the transmission-destination terminal unit in place of the access information.

23. An information storage medium, which is a computer-readable information storage medium, for storing a program according to claim 9.

24. The method of managing an attached file according to claim 12,
wherein the electronic information further comprises an electronic mail, and
the server transmits the access information to the transmission-destination terminal unit of the electronic mail.

25. The method of managing an attached file according to claim 12,
wherein the server storage information includes last-update date-and-time information of the file,
the server determines whether there is a duplicate file based on the file identification information and the server storage information at least at one of regular time intervals and in response to a user request, and if there is a duplicate file, the server deletes the duplicate file.

26. The method of managing an attached file according to claim 25,
wherein the server performs the steps of:
generating a file-clean-up electronic mail prompting the user to clean up the files if there is a duplicate file; and
transmitting the file-clean-up electronic mail to the transmission-source terminal unit.

27. The method of managing an attached file according to claim 25,
wherein the terminal unit performs the steps of:
storing a plurality of the files and terminal storage information indicating identification information and storage location information of the files in a predetermined storage area; and
generating electronic information including update means for updating the file and the terminal storage information, and
the identification information of the files and storage location information of the files,
the server performing the steps of:
if there is a duplicate file, generating a file-deletion electronic mail in order to delete the duplicate file; and
transmitting the file-deletion electronic mail to the transmission-source terminal unit, and
the terminal unit performing the steps of:
deleting the duplicate file based on the file-deletion electronic mail, and updating the terminal storage information.

28. The method of managing an attached file according to claim 24 wherein the server performs the steps of:
managing at least one of an access right of the storage area and the file indicated by the storage location information for each of the terminal units; determining whether the transmission-destination terminal unit has the access right based on an electronic mail transmitted by the terminal unit, and if the transmission-destination terminal unit does not have the access right, transmitting the electronic mail transmitted by the terminal unit to the transmission-destination terminal unit in place of the access information.
